(19) United States
(12) Patent Application Publication
(10) Pub. No.: US 2005/0073121 A1
(43) Pub. Date: Apr. 7, 2005

(54) SCOOTER FOLDING STRUCTURE

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/676,104

(22) Filed: Oct. 2, 2003

(51) Int. Cl. B62M 1/00

(52) U.S. Cl. 280/87.05

(57) ABSTRACT

A scooter folding structure includes a handle tube, a skateboard and a fastener device. The handle tube has a strut at a lower portion. The skateboard has a connecting block at a front end connected with the strut of the handle tube. The strut includes a base having a boss extending upward. The connecting block comprises a pair of connecting parts at a distance with each other. Each connecting part has a position hole thereon. The connecting block has a pair of locating studs on one side thereof. The fastener device comprises a rod, a knob, and a spring. The rod is sleeved with the spring, and then inserted through the boss of the base of the handle tube and connected with the knob. The rod has a threaded section threaded to the position hole of one of the connecting parts.

### FIELD OF THE INVENTION

This invention relates to a scooter, and more particularly to a scooter having a folding structure.

### BACKGROUND OF THE INVENTION

There are varies types of scooter on the market. They are popular to users due to their mobility and they are foldable for easy carriage. The folding structure of current products is generally composed of an upper unit and a lower unit secured by a locating fastener. The locating fastener is easy to be loosened when hit by a foreign object.

Therefore, a new folding structure has been derived, which uses a pulling spring to secure the structure and to adjust the upper unit and the lower unit to fold the product. However, sometimes the spring may get stuck and clip the user's finger to cause an accident.

### SUMMARY OF THE INVENTION

It is the primary advantage of the present invention to provide a scooter folding structure, which is easy to operate.

It is another advantage of the present invention to provide a scooter folding structure, which is safe in operation.

### BRIEF DESCRIPTION OF THE DRAWINGS

FIG. 1 is a side view of the present invention;

FIG. 2 is an exploded view of the present invention;

FIG. 3 is an enlarged partial cross-sectional view of the folding structure of the present invention;

FIG. 4 is an enlarged view of the connecting part of the present invention, and

FIG. 5 is sectional view of the present invention in a folding status.

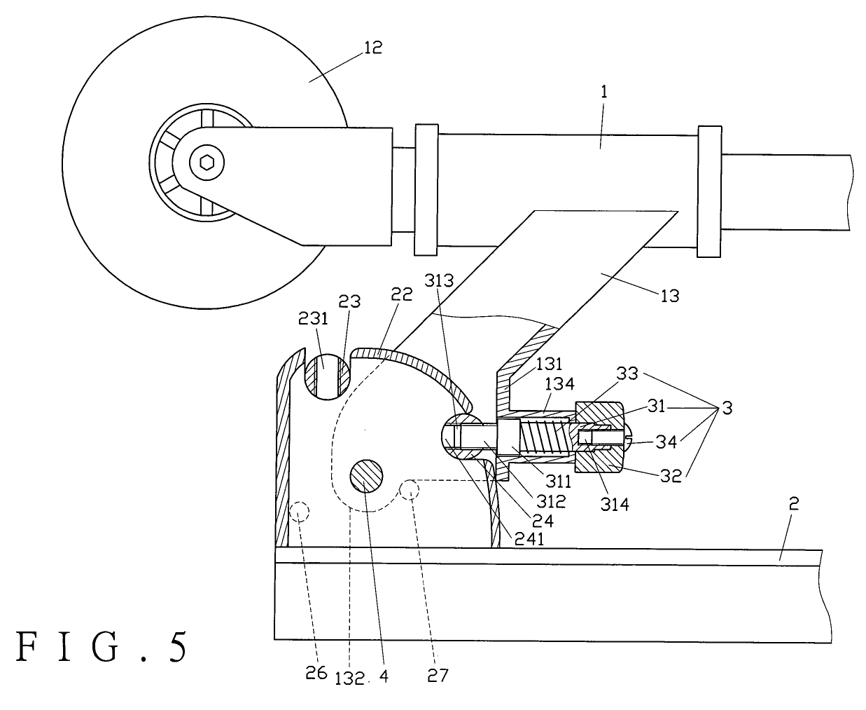

### DETAILED DESCRIPTION OF THE PREFERRED EMBODIMENTS

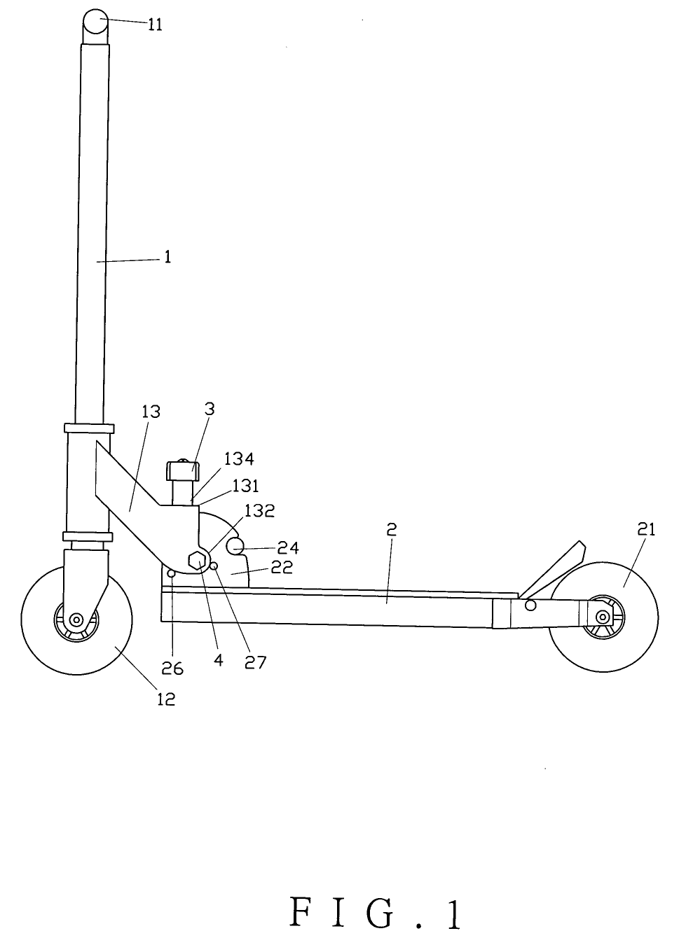

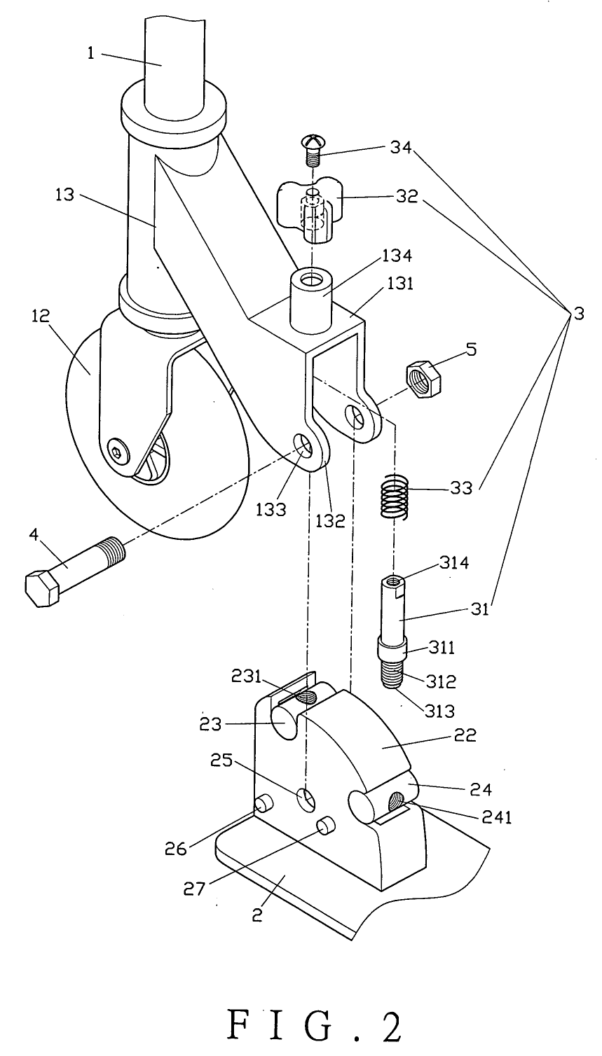

The present invention, as shown in FIGS. 1 and 2, comprises a handle tube 1, a skateboard 2, and a fastener device 3.

The handle tube 1 includes a handle 11 secured on the top end, a roller 12 at the bottom end, and a strut 13 extending from the lower portion in a slanting way. The strut 13 has a base 131 vertically formed at one end thereof with a ridge 132 extending from the bottom end of the base 131. The base 131 further comprises a pair of through holes 133 and a boss 134 protruding from the top end thereof.

The skateboard 2 has a roller 21 secured to the rear end, and an arc connecting block 22 at the front end thereof. The connecting block 22 comprises a pair of connecting parts 23 and 24 at a 90-degree angle to each other. The connecting part 23 has a position hole 231, and the connecting part 24 has a position hole 241. The connecting block 22 further comprises a locating hole 25 and a pair of locating studs 26 and 27 on one side thereof.

The fastener device 3 includes a rod 31, a knob 32 and a spring 33. The rod 31 has an enlarged section 311 at the lower portion. When the spring 3 is sleeved onto the rod 31 from the top of the rod 31, the spring 3 will be stopped by the enlarged section 311. The rod 31 further comprises a threaded section 312 underneath the enlarged section 311 and an engaging tip 313 at the bottom. The top end of the rod 31 is provided with a threaded hole 314 adapted to secure the knob 32 with a bolt 34.

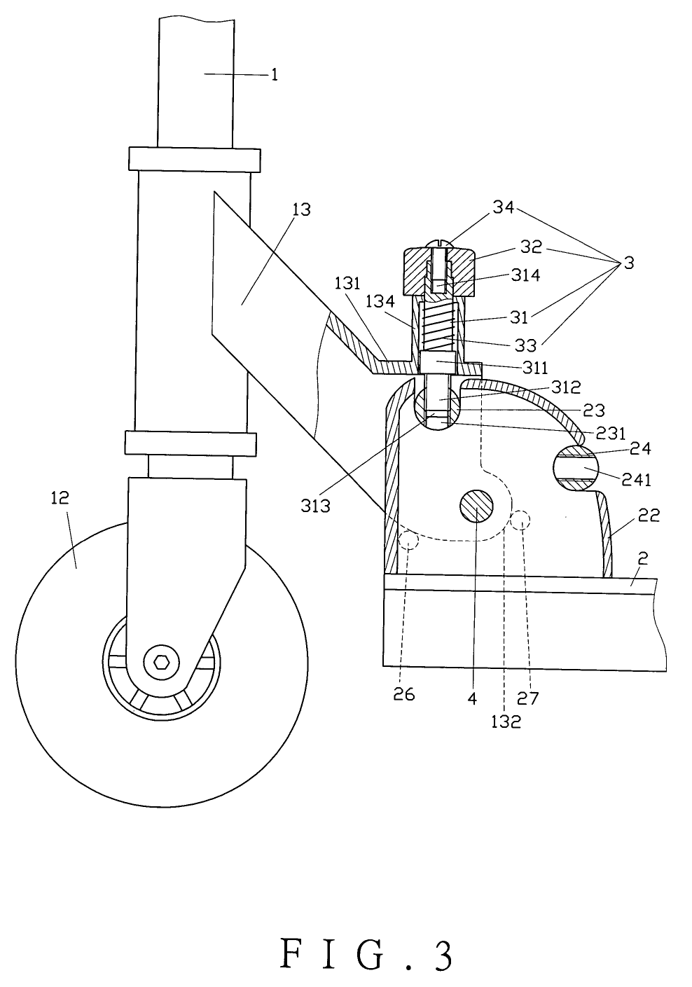

To assemble the present invention, as shown in FIG. 3, the spring 3 is sleeved onto the rod 31 and then slid into the boss 134 of the base 131 from the bottom towards the top direction so that the top portion of the rod 31 will be extended outwardly from the boss 134. The knob 32 is placed on the top of the rod 31. The bolt 34 is inserted and threaded with the threaded hole 314 of the rod 31. This secures the knob 32 and the rod 31 to the boss 134 of the base 131. The base 131 of the handle tube 1 is placed onto the connecting block 22 with the through holes 133 aligned with the locating hole 25 of the connecting block 22, and then a bolt 4 is inserted from one side and secured with a nut 5 from the other side thereof The engaging tip 313 of the rod 31 is inserted into the position hole 231 of the connecting part 23, and the threaded section 312 of the rod 31 is threaded to the position hole 231 of the connecting part 23. The handle tube 1 is securely fastened to the skateboard 2 in a straight position with respect to the skateboard 2. The ridge 132 of the base 131 is engaged with the locating stud 26, which provides a stable assistant to the handle tube 1.

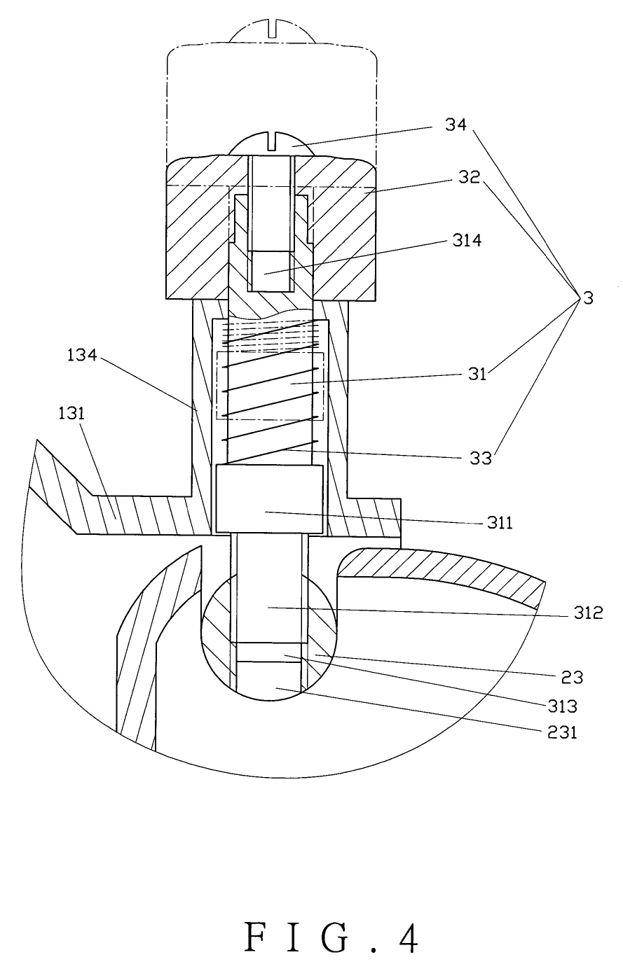

To fold the present invention, ass shown in FIG. 4, the knob 32 is rotated to release the threaded section 312 of the rod 31 from the position hole 231 of the connecting part 23. The knob 32 is pulled upwardly to bring the engaging tip 313 away from the position hole 231 and the handle tube 1 is free to move. The handle tube 1 is pushed downward until the engaging tip 313 has reached the position hole 241 of the connecting part 24. The spring 33 will urge the rod 31 downward, and then the threaded section 312 of the rod 31 is threaded to the position hole 241 of the connecting part 24 to hold the rod 31 securely in the position hole 241. The ridge 132 of the base 131 engages with the locating stud 27. The handle tube 1 is fastened securely.

1. A scooter folding structure comprising a handle tube, a skateboard and a fastener device, said handle tube comprising a handle at a upper end and a roller at a lower end and a strut extending from a lower portion in a slanting direction, said skateboard comprising a roller at a rear end and a connecting block at a front end;
said strut of said handle tube comprising a base extending from one end of said strut, a boss protruding from a top end of said base;
said connecting block comprising a pair of connecting parts with a position hole on each said connecting part and a pair of locating studs on one side thereof;
said fastener device comprising a rod, a knob and a spring, said rod having an enlarged section adapted to receive said spring, said rod further comprising a threaded section underneath said enlarged section, said knob secured to a top end of said rod thereof, and
said rod being sleeved with said spring and inserted through said boss and connected with said knob and then secured by a bolt, said base of said handle tube pivoted to said connecting block with said rod of said fastener device inserted into said position hole of said one of the connecting parts, said base of said handle tube having a bottom edge engaging with said one of the locating studs of said connecting block to confine random movement of said handle tube.

2. The scooter folding structure, as recited in claim 1, wherein said base of said handle tube comprises a ridge at the bottom edge to engage with said one of the locating studs.
